(19) United States
(12) Patent Application Publication
(10) Pub. No.: US 2006/0069176 A1
(43) Pub. Date: Mar. 30, 2006

(54) Polymer derived ceramic materials

(76) Inventors: Christopher N. Bowman, Boulder, CO (US); Neil Cramer, Boulder, CO (US); Sirish Reddy, Boulder, CO (US)

Correspondence Address: Quine Intellectual Property Law Group, P O Box 458, Alameda, CA, 94501, US

(21) Appl. No.: 10/523,659

(22) PCT Filed: Aug. 20, 2003
(86) PCT No.: PCT/US03/26406

§ 371 Date: Feb. 4, 2005

Related U.S. Application Data
(60) Provisional application No. 60/405,046, filed on Aug. 20, 2002.

(51) Int. Cl. C08F 2/46

(52) U.S. Cl. 522/1

(57) ABSTRACT

The invention provides a composition that includes a first monomer comprising at least one ethylenically unsaturated group and at least one Si—N linkage, and a second monomer comprising at least one thiol functional group. The invention also provides a method of forming a ceramic material and process for forming a three-dimensional ceramic material.

### COPYRIGHT NOTIFICATION

Pursuant to 37 C.F.R. § 1.71(e), Applicants note that a portion of this disclosure contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

### CROSS-REFERENCES TO RELATED APPLICATIONS

This application claims the benefit of U.S. Provisional Application No. 60/405,046, filed Aug. 20, 2002, the disclosure of which is incorporated by reference.

### FIELD OF THE INVENTION

The present invention relates generally to ceramic materials and to methods of forming these materials.

### BACKGROUND OF THE INVENTION

The photopolymerization or radiation-based curing of light sensitive materials is a multibillion dollar business. The photopolymer products of these processes are typically derived from polymers, oligomers, and/or monomers that can be selectively polymerized and/or crosslinked upon imagewise exposure to various types of electromagnetic radiation, including ultra-violet light, visible light, and electron beam radiation. Significant advantages that photopolymerizable systems have over other polymerization techniques, such as traditional thermal processing methods, include low energy requirements, spatial and temporal control of initiation, solvent-free formulations, and high polymerization rates at room temperature. They also provide tremendous chemical versatility in view of the wide range of monomers that can be photochemically polymerized.

Due to this unique set of advantages, photopolymerization systems have gained prominence for the solvent-free curing of polymer films as well as emerging applications in biomedical materials, conformal coatings, electronic and optical materials, and rapid prototyping of three dimensional objects. More specifically, photopolymers are made into different forms including films, sheets, liquids, and solutions, which are utilized in, e.g., printing plates, photoresists, stereolithography, and imaging. To further illustrate, photoresists are used to fabricate integrated circuits, flat panel displays, printed circuits, screen printing products, chemically milled parts, and micro- and nano- electromechanical systems (MEMS/NEMS). Liquid compositions can also be used for non-imaging applications such as adhesives, coatings, paints, inks, and related photosensitive products. Photopolymerizations also have in vivo applications in, e.g., open environments such as the oral cavity in addition to uses in invasive and minimally invasive surgery. In vivo photopolymerizations have even been performed transdermally.

For many of these applications, materials that substantially retain their chemical and mechanical properties at elevated temperatures are desirable. To further illustrate, representative applications sought for such high temperature resistant materials include devices such as microcombustors, micro-heat-exchangers, sensor and actuator systems, microfluidic devices, and micro-optics systems that can be used independently or integrated into other systems, such as MEMS/NEMS. Polymers, silicon, and glass are commonly used materials for making, e.g., MEMS/NEMS, though many of these materials are not suitable for high temperatures (e.g., in excess of 1000° C.) or other harsh environmental applications. Ceramics that can resist high temperatures are a good alternative for these and many other applications.

To date, there have only been a few processing techniques capable of producing ceramic materials for applications, such as MEMS/NEMS. For example, powder sintering is one conventional process used for making ceramic structures (Riedel et al. (1992) Nature 355:714). However, the additives used in these materials for densification tend to reduce the mechanical properties of the resulting ceramic structures, rendering materials formed by this process unsuitable for many applications. Further, the dimensional tolerances of the resultant structures are dependent on the uniformity and the purity of the powder packing, which can be difficult to control in small scale structures. Another ceramic MEMS/NEMS technique is based upon chemical vapor deposition (CVD) of silicon carbide (SiC) followed by micromachining. Slow deposition rates (20 to 50 μm/hour) of SiC and complex micromachining make this process undesirable for many uses. In addition, injection molding using either liquid polymer precursors (Liew et al. (2000) Sensors and Actuators A 89:64) or ceramic powders (Chen et al. (2001) J. Microelectromechanical Systems 10(1):62) has been used to make ceramic structures. However, the ceramic structures produced by injection molding techniques must be separated from molds, which tends to severely restrict structure geometry, limit production throughput, and adds to the cost of production.

### SUMMARY OF THE INVENTION

The invention provides methods of rapidly fabricating polymer derived ceramic materials (e.g., with controlled shapes and structures) and related compositions. The reaction schemes described herein are largely based upon a thiol-ene photopolymerization mechanism. Thiol-ene photopolymerizations provide various advantages including high polymerization speeds in the presence of little or no photoinitiator, the ability to delay gelation, and the ability to achieve high double bond conversions. The addition of thiols to polymerizable vinyl containing ceramic precursors further permits the formation of structures that are thicker than those achievable using pre-existing approaches. Upon transformation, e.g., by pyrolysis, the polymer structures typically form ceramic structures of self-similar shapes. In pyrolysis steps, structures formed using the approaches described herein generally show similar shrinkage and mass loss values as displayed by those produced from more traditional ceramic precursors. Furthermore, the lithographic processes (e.g., layer-by-layer solid imaging, etc.) described herein are readily adapted to make complex three-dimensional ceramic microstructures and microdevices among many other applications exemplified herein.

In one aspect, the invention relates to a composition that includes (a) a first monomer comprising at least one ethylenically unsaturated group (e.g., a polymerizable ethylenically unsaturated group) and at least one Si—N linkage (e.g., a silazane, etc.), at least one Si—O linkage (e.g., a siloxane, etc.), and/or at least one Si—C linkage (e.g., a carbosilane, etc.), and (b) a second monomer comprising at least one thiol functional group. In some embodiments, the first monomer includes at least one vinyl functional group, and/or at least three Si—N linkages, at least three Si—O linkages, and/or at least one Si—C linkages. To illustrate, the first monomer is optionally represented by formula (I) (i.e., KiON™ CERASET SN (or “CERASET”)(KiON Corporation (USA)): 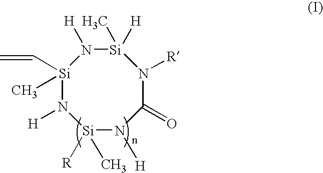
where n is an integer from 1-20, R is H or CH═CH₂, and R′ is an organic group comprising from 1-20 carbon atoms. To further illustrate, the first monomer is optionally represented by formula (II) (i.e., KiON™ VL20 (or “VL20”)(KiON Corporation (USA)): 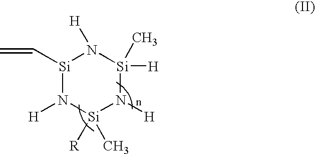
where R is H or CH═CH₂, and n is an integer from 1-20. Typically, the second monomer comprises two or more thiol functional groups. To illustrate, the second monomer is optionally represented by formula (III) (i.e., pentaerythritol tetra(3-mercaptopropionate) (or “tetrathiol”)): 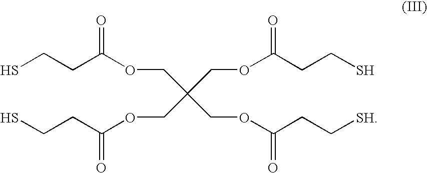
In certain embodiments, the composition comprises a photoinitiator.

The invention also relates to a method of forming a ceramic material. The method includes (a) reacting at least a first monomer comprising at least one ethylenically unsaturated group with at least a second monomer comprising at least one thiol functional group to form a polymeric material. Typically, step (a) comprises one or more of: irradiating a composition comprising the first and second monomers, contacting (e.g., mixing, etc.) a photoinitiator with a composition comprising the first and second monomers, heating a composition comprising the first and second monomers, or contacting a catalyst (e.g., a polymerization catalyst, etc.) with a composition comprising the first and second monomers. In some embodiments, the molar ratio of the first monomer (e.g., ethylenically unsaturated groups of the first monomer) to the second monomer (e.g., thiol functional groups of the second monomer) is at least 1:1 in step (a), whereas in others, the molar ratio of the second monomer to the first monomer is more than 1:1 in step (a). In particular, the molar ratio of the ethylenically unsaturated groups of the first monomer, having a functionality of x in ethylenically unsaturated groups, to the thiol functional groups of the second monomer, having a functionality of y in thiol groups, is preferably in the range between 1:(x−1)(y−1) to (x−1)(y−1):1 in, e.g., step (a). For example, if the molar functionality of the ethylenically unsaturated of the first monomer is 3, and the thiol functionality of second monomer is 4, then the molar ratio of ethylenically unsaturated groups to the thiol functional groups is preferably in the range of 1:6 to 6:1. (as (4−1)*(3−1)=6 ). In addition, the method includes (b) heating (e.g., pyrolyzing, etc.) the polymeric material to form the ceramic material. For example, step (b) is typically performed at a temperature of at least 700° C. Optionally, the method includes other steps, such as (c) sintering the ceramic material.

In some embodiments of the method, the first monomer includes at least one vinyl functional group, and/or at least one Si—N linkage, at least one Si—O linkage, and/or at least one Si—C linkage. For example, the first monomer is optionally represented by formula (I): 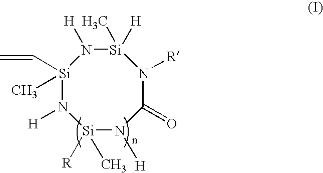
where n is an integer from 1-20, R is H or CH═CH₂, and R′ is an organic group comprising from 1-20 carbon atoms. To further illustrate, the first monomer is optionally represented by formula (II): 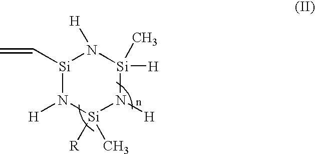
where R is H or CH═CH₂, and n is an integer from 1-20. Typically, the second monomer comprises two or more thiol groups. To illustrate, the second monomer is optionally represented by formula (III):

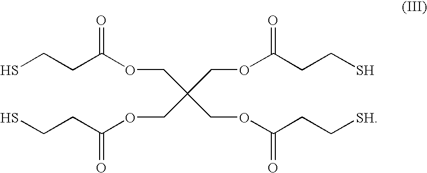

The invention also provides a method of forming a three-dimensional ceramic material. The process includes (1) coating a layer of a composition onto a surface, where the composition is as described above, and (2) exposing the layer imagewise to actinic radiation to form an imaged cross-section in which the radiation is of sufficient intensity to cause substantial curing of the layer in the exposed areas. The process also includes (3) coating a layer of the composition onto the previously exposed imaged cross-section, and (4) exposing the layer from step (3) imagewise to actinic radiation to form an additional imaged cross-section in which the radiation is of sufficient intensity to cause substantial curing of the layer in the exposed areas and to cause adhesion to the previously exposed imaged cross-section. In addition, the process further includes (5) repeating steps (3) and (4) a sufficient number of times in order to build up a three-dimensional article, and (6) pyrolyzing the three dimensional article to form the three dimensional ceramic material. In certain embodiments, the method further includes separating exposed regions of the layer of the composition from unexposed regions of the layer of the composition, e.g., prior to step (6).

### BRIEF DESCRIPTION OF THE DRAWINGS

FIGS. 1A-D schematically illustrate the chemical structures of tetrathiol, dithiol, CERASET, and VL20 monomers, respectively.

FIGS. 2A and B are FTIR traces showing double bond conversion versus time for polymerization of bulk CERASET (—) and bulk VL20 ( - - - ) (FIG. 2A) and 1:1 weight fraction of tetrathiol in CERASET (—) and 1:5 weight fraction of tetrathiol in VL20 ( - - - ) (FIG. 2B). VL20 samples were irradiated at 57 mW/ cm² at a wavelength of 365 nm using 6 wt % DMPA for bulk VL20 polymerization and 0.02 wt % DMPA for tetrathiol-VL20 polymerization. CERASET samples irradiated at 20 mW/cm² using 1.3 wt % DMPA for bulk CERASET and 0.7 wt % DMPA for thiol-CERASET.

FIG. 3 shows a side view of photopolymerized cylindrical structure 6 mm in length with an outside diameter of 3.2 mm. The structure was made from a 1:5 weight ratio of tetrathiol and VL20 irradiated at 50 mW/cm² at a wavelength of 365 nm using 0.02 wt % DMPA, with curing from the top.

FIGS. 4 A and B show photopolymerized electrostatic actuator structures from 15 wt % dithiol in CERASET with 0.2 wt % DMPA. In particular, FIG. 4A shows polymer structures and FIG. 4B shows the structures after pyrolysis. A thickness of 1200 μm and a width of 80 μm (15:1 aspect ratio) were obtained in these structures.

FIGS. 5A and B are images showing warping of polymer films formed from VL20 (FIG. 5A) and 1:5 weight ratio of a thiol-VL20 mixture (FIG. 5B). 6 wt % of DMPA was used in curing of pure polysilazane, while 0.02 wt % DMPA was used in curing the thiol-VL20 system. Both systems were irradiated at 50 mW/cm² at a wavelength of 365 nm.

FIGS. 6A-E show images of a photolithographic mask, polymer, and pyrolized ceramic. In particular, FIG. 6A shows a polymer 2-D channel of 800 μm made from 1:5 (wt ratio) of tetrathiol:VL20. FIG. 6B shows a pyrolyzed sample made from the pyrolysis of the device shown in FIG. 6A. FIGS. 6C and D show a top view and a side view, respectively, of an 800 μm polymer 3-D channel filled with red dye. FIG. 6E shows the sample from FIGS. 6C and D after pyrolysis with the 3-D channel.

### DETAILED DISCUSSION OF THE INVENTION

Before describing the present invention in detail, it is to be understood that this invention is not limited to particular compositions or methods, which can, of course, vary. It is also to be understood that the terminology used herein is for the purpose of describing particular embodiments only, and is not intended to be limiting. Further, unless defined otherwise, all technical and scientific terms used herein have the same meaning as commonly understood by one of ordinary skill in the art to which this invention pertains. In describing and claiming the present invention, the following terminology and grammatical variants will be used in accordance with the definitions set forth below.

A “functional group” or “group” refers to a group of atoms that represents a potential reaction site in a compound. For example, certain monomers described herein comprise ethylenically unsaturated groups (e.g., acrylate groups, methacrylate groups, vinyl functional groups, vinylether groups, allyl groups, double-bonds in ring structures such an norbornene, etc.) and/or thiol functional groups.

An “organic group” refers a group that includes at least one carbon atom, but which may include additional substituent or functional groups, such as amino, alkoxy, cyano, hydroxy, carboxy, halo, acyl, alkyl, cycloalkyl, hetaryl, aryl, allylic, vinylic, arylene, benzylic, derivatives thereof, and the like. Organic groups can be cyclic or acyclic. Exemplary organic groups can be derived from esters, ketones, alcohols, epoxides, polyols, ethers, phenols, aldehydes, quinones, carboxylic acids, derivatives thereof, and the like. Although an organic group utilized herein can have essentially any number of carbon atoms, organic groups typically include about 2-20 carbon atoms, and more typically include about 3-15 carbon atoms.

An “ethylenically unsaturated group” refers to a linear, branched, or cyclic unsaturated hydrocarbon group that comprises one or more carbon-carbon double bonds. An ethylenically unsaturated group can be substituted or unsubstituted. Exemplary ethylenically unsaturated groups include vinyl, allyl, butenyl, pentenyl, hexenyl, (meth)acryloyl, and the like.

A “thiol functional group” refers to a sulfhydryl (—SH) group or to a group that comprises a sulfhydryl group.

A “linkage” refers to two or more atoms that are covalently attached to one another. In certain embodiments of the invention, for example, monomers comprise one or more Si—N linkages, Si—O linkages, and/or Si—C linkages. Typically, the Si—N—Si linkages comprise the Si—N linkages, Si—O—Si linkages comprise the Si—O linkages, and Si—C—Si linkages comprise the Si—C linkages.

A “polymeric material” refers to a compound that includes two or more monomeric units. A polymeric material of the invention typically includes monomeric units derived (e.g., through a chemical modification, such as a polymerization reaction, etc.) from monomers described herein.

The term “pyrolysis” refers to the transformation of a compound into one or more other substances by heat alone (i.e., without oxidation).

This invention relates to ceramic material formation, e.g., for MEMS/NEMS among many other applications utilizing thiol-ene photopolymerizations. The photopolymerization of liquid ceramic precursors via this reaction technique provides an alternative to pre-existing technologies. In particular, the curing rates of the photopolymerizations of the invention are typically improved by several orders of magnitude relative to those achieved using pre-existing approaches without changing the curing conditions except for typically reducing, if not eliminating the amount of photoinitiator used. Also, the extent vinyl conversion is typically improved relative to these other approaches. In addition, the polymerizations of the invention may permit direct pyrolysis of polymeric materials without pre-baking to form ceramic materials that are generally stable at elevated temperatures (e.g., up to about 1500° C.). Moreover, the invention can be readily used for photopatterning and forming complex three-dimensional (3-D) structures. Ceramic materials produced according to the methods of the invention can typically be produced with greater thickness, complexity, durability, and enhanced lithographic and/or mechanical properties than many preexisting techniques. The compositions and methods of the invention can also be used in rapid prototyping applications. These and many other applications are described or otherwise referred to herein.

Previously, the vinyl silyl groups of preceramic materials such as KION™ VL20 polysilazane have been homopolymerized via a traditional photopolymerization using free radical initiators such as 2,2-dimethoxy-2-phenylacetophenone (DMPA). The reaction is photoinitiated with ultraviolet light and is thought to proceed via a chain growth polymerization mechanism to produce crosslinked polymer networks. These traditional free radical photopolymerizations of polymer derived ceramics have proven quite effective in facilitating patterning and formation of these materials. However, as referred to above, they are severely limited in both the reaction rates and extent of functional group conversions that they achieve. Low functional group conversions typically warrant an extended pre-baking time in order to prevent significant weight loss during pyrolysis. Prior to the present invention, no UV initiator system had been developed for rapid or substantially complete photopolymerization of these preceramic materials.

It is well established that thiol-ene photopolymerizations proceed more rapidly than typical photopolymerizations and that a much greater variety of vinyl (or “ene”) monomers are highly reactive in these polymerizations, even when they are not reactive in homopolymerizations (see, e.g., Jacobine, Radiation Curing in Polymer Science and Technology III, Polymerisation Mechanisms, Vol. 3, Elsevier Applied Science, London (1993), p. 219, and Cramer et al. (2001) J. Polym. Sci., A. Polym. Chem. 39:3311).

The compositions and methods of the invention include vinyl(ene) ceramic precursor monomers (i.e., monomers comprising at least one ethylenically unsaturated group and at least one Si—N linkage), and organic or inorganic thiol monomers, which are typically multifunctional (i.e., monomers comprising at least two thiol functional group). An enormous number of vinyl(ene) ceramic precursor monomers and thiol monomers can be used in practicing the present invention and will be readily apparent to persons of skill in the art. Accordingly, no attempt is made herein to list all of the possible monomers that are optionally utilized. However, various representative vinyl(ene) ceramic precursor monomers and thiol monomers are provided herein to further illustrate the invention.

Essentially any vinyl polysilazane, vinyl carbosilanes, and vinyl siloxanes that can be ceramised through pyrolysis is optionally utilized as vinyl(ene) ceramic precursor monomer to make ceramic materials using the thiol-ene polymerization schemes described herein. These vinyl(ene) monomers can also include other heteroatoms including, e.g., B, Al, Ti, and the like. Some exemplary vinyl(ene) monomers are optionally selected from, e.g., polycarbosilazane, poly(silsesqui-N-methylsilazane), polyvinylsilazane, poly(N-methylsilazane), polymethylsilazane, polysilazane, polyhydridodisilazane, polyethylenesilazanes, polymethyldisilazane, polysiladiazanes, polysilacyclobutasilazane, octamethylcyclotetrasilazane, polyborsilazane, polyvinylsilazane, polydihydrosilazane, polymethylsilazane, cyclodisilazane, polyborosilazane, polysilacyclobutasilazane, polycarbosilazane, polyvinylmethylsilazane, poly(hydrazinomethylsilane), poly(ureidosilazanes), polyvinylsilazane, polyborosilazane, poly(disilazane), and the like.

Additional exemplary vinyl(ene) ceramic precursor monomers that are optionally utilized include, e.g., 1,3-Divinyl-1,1,3,3-tetramethyl disilizane, 1,3-dimethyl-1,3-diphenyl-1,3-divinyldisilazane, 1,3,5-trimethyl-1,3,5-trivinylcyclotrisilazane, 1,3,5,7-tetramethyl-1,3,5,7-tetravinyl-cyclotetrasilazane, CERASET™ SN, VL20, Pyrofine PV, VT50, HVNG, PVS, 1,5-divinyl-3,3-diphenyl-1,1,5,5-tetramethyltrisiloxane, 1,3-divinyl-1,3-diphenyl-1,3-dimethyldisiloxane, 1,3,5,7-tetravinyl-1,3,5,7 tetramethylcyclotetrasiloxane, 1,3,5,7-tetravinyl-1,3,5,7-tetramethyl cyclo tetrasiloxane, 1,1,3,3-Tetramethyldisilazane, 1,1,1,3,3,3-Hexamethyldisilazane (HMDS), 1,3-Diphenyl-1,1,3,3-tetramethyldisilazane (DPTMDS), 1,3-Divinyl-1,1,3,3-tetramethyldisilazane, 1,3-Dimethyl-1,1,3,3-tetraphenyldisilazane, 1,3-Bis(chloromethyl)-1,1,3,3-tetramethyldisilazane, 1,3-Di-n-butyl-1,1,3,3-tetramethyldisilazane, 1,3-Dimethyl-1,3-diphenyl-1,3-divinyldisilazane, heptamethyldisilazane, tris(trimethylsilyl)amine or nonamethyltrisilazane or nitrilotris(trimethylsilane), 4-Bromo-N,N-bis(trimethylsilyl)aniline, germanium(II)-bis[bis(trimethylsilyl)amide], tin(II)-bis[bis(trimethylsilyl)amide], 2,2-thiobis(1,1,1,3,3,3-hexamethyldisilazane), tris(dimethylaminosilyl)aminobis (dimethylamino)borane, 2,2,5,5-Tetramethyl-2,5-disila-1-aza-cyclopentane, 1,1,3,3,5,5-hexamethyl-cyclotrisilazane (HMCIS), 1,2,3,4,5,6-hexamethyl-cyclotrisilazane, 1,3,5-triethyl-2,4,6-trimethylcyclotrisilazane, 1,3,5-trimethyl-1,3,5-trivinylcyclotrisilazane, 1,1,3,3,5,5,7,7-octamethyl-cyclotetrasilane (OMCTS), 1,3,5,7-Tetraethyl-2,4,6,8-tetramethyl-cyclotetrasilazane, 1,3,5,7-tetramethyl-1,3,5,7-tetravinyl-cyclotetrasilazane, oligoborosilazane, polyborosilazane, oligoborosilazane, PSN-2M01: poly(1,1-dimethylsilazane) telomer, PSN-2M02: poly(1,1-dimethylsilazane), PSN-2M11: poly(1,2-dimethylsilazane), ET 70, VB 40, VT 50, NCP 100, NCP 200, NN 110, perhydropolysilazane, NN 710 (SNC), NN 310, HVNG, BPS, ABSE, and the like.

Essentially any compound having at least one thiol functional group is optionally utilized as a thiol monomer in the present invention. Typically compounds having two or more thiol groups per molecule are used. Exemplary polythiol compositions include, e.g., polymercaptoacetate and/or polymercaptopropionate esters, in particular the pentaerythritol tetra esters and/or trimethylolpropane triesters. More specific thiol monomers that are optionally utilized include, e.g., pentaerythritol tetra(3-mercaptopropionate), trimethylolpropane tris(3-mercaptopropionate), pentaerythritol tetra(2-mercaptoacetate), trimethylolpropane tris(2-mercaptoacetate, 1,6-hexanedithiol, 1,2-benzenedithiol, 1,3-benzenedithiol, and the like.

Various synthetic and purification techniques that can be adapted for use in the synthesis of vinyl(ene) ceramic precursor monomers and thiol monomers protocols, and in the polymerization reactions of the invention are generally known and described in, e.g., Kroke et al. (2000) Materials Science and Engineering, 26(2000):97-199, March, Advanced Organic Chemistry: Reactions, Mechanisms, and Structure, 4^{th} Ed., John Wiley & Sons, Inc. (1992), Carey and Sundberg, Advanced Organic Chemistry Part A: Structure and Mechanism, 4th Ed., Plenum Press (2000), which are each incorporated by reference. Chemical starting materials and other reaction components useful in the synthesis of the monomers of the invention are also readily available from various commercial suppliers including, e.g., KiON Corporation (USA), Hampshire (USA), Sigma-Aldrich, Inc. (USA), Tonen Corp. (Japan), Bayer AG (Germany), Elf Attochem (France), Gelest Inc. (USA), Hoechst AG (Germany), Nichimen Inc. (Chisso, Japan), and the like.

The methods of forming a ceramic material of the invention typically include irradiating (e.g., with ultra-violet radiation, etc.) a composition (e.g., a radiation curable composition, etc.) or reaction mixture that comprises at least a first monomer comprising at least one ethylenically unsaturated group (i.e., a vinyl(ene) ceramic precursor monomer) and at least a second monomer comprising at least one thiol functional group (i.e., a thiol monomer) to form a polymeric material. Essentially any combination of vinyl(ene) ceramic precursor monomer and thiol monomer can be included in the compositions of the invention. In some embodiments, more than one type of vinyl(ene) ceramic precursor monomer and/or thiol monomer can be present in the composition to be polymerized. To illustrate, a radiation curable composition of the invention optionally comprises both KiON™ VL20 and KiON™ CERASET SN polysilazanes in addition to pentaerythritol tetra(3-mercaptopropionate). In addition, the compositions of the invention optionally further include additional monomers having other types of radiation curable functional groups, such as vinylether, fumarate, maleate, oxolane, epoxy, itaconate, and/or other groups.

The polymerizable compositions used in these processes are typically varied according to the desired material properties (e.g., strength, hardness, flexibility, insolubility, etc.) sought in the polymer product. In certain embodiments, for example, a composition of the invention includes at least one monomer described herein in an amount of at least about 1% by weight of the total amount of components in the composition, preferably at least about 5% by weight, more preferably at least about 10% by weight, even more preferably at least about 15% by weight and still more preferably at least about 25% by weight (e.g., at least about 35%, 45%, 55%, 65%, 75%, or more by weight of the total amount of components in the composition). Additional details relating to the particular monomers selected for inclusion in a given composition are described, e.g., in the examples provided below.

In some embodiments, the compositions of the invention further include quantities (e.g., a few % by weight) of photocrosslinking or photo-polymerization initiators, solvents/diluents (e.g., reactive and/or non-reactive diluents), photosensitizers/synergists (e.g., diethylamine, triethylamine, ethanolamine, ethyl 4-dimethylaminobenzoate, 4-dimethylaminobenzoic acid, and the like), and/or additives typically utilized in polymerizable compositions. Exemplary initiators which are optionally utilized include benzoin ethers and phenone derivatives such as benzophenone or diethoxyacetophenone, either by themselves or in combination with a tertiary amine, e.g., methyldiethanolamine, etc. More specific exemplary photo-polymerization initiators include, e.g., 3-methylacetophenone, xanthone, fluorenone, fluorene, 2-hydroxy-2-methyl-1-phenylpropan- 1-one, triphenylamine, thioxanethone, diethylthioxanthone, 2,2-dimethoxy-2-phenylacetophenone, benzyl methyl ketal, 2,4,6-trimethylbenzoyldiphenylphosphine, and the like. Other initiators that are also optionally utilized are generally known in the art to which this invention pertains. Mixtures of initiators are also optionally utilized. Photo-polymerization initiators are available from a variety of commercial suppliers including, e.g., Ashland, Inc., UCB, BASF, Ciba Specialty Chemicals Co., Ltd., etc. Although compositions having higher initiator contents are optionally utilized, compositions with a low initiator content (e.g., 1 wt % or less), or containing no initiator, are typically preferred. Compositions with lower levels of an initiator are typically more transparent to UV or other forms of electromagnetic radiation, which makes it possible to polymerize in greater depths, e.g., in thicknesses of 1 cm or more.

Polymerizable compositions (e.g., coating compositions, etc.) utilized to produce the polymers of the present invention may also contain essentially any additive that is typically utilized in these processes, such as agents for adjusting the surface gloss of the polymer, surfactants, filers, colorants, antioxidants, UV absorbers, heat polymerization inhibitors, light stabilizers, silane coupling agents, coating surface improvers, leveling agents, preservatives, plasticizers, lubricants, solvents, aging preventives, and the like. In certain embodiments, amine compounds (e.g., diethylamine, diisopropylamine, diallylamine, etc.) can be added to polymerizable composition to prevent the generation of hydrogen gas. These and other additives are generally known in the art and readily available from many different commercial sources, such as UCB, Ashland, Inc., Sigma-Aldrich, Inc., BASF, Ciba Specialty Chemicals Co., Ltd., Sankyo Co., Ltd., Sumitomo Chemical Industries Co., Ltd., Shin-Etsu Chemical Co, Ltd., and the like.

The polymerization reactions of the invention may be performed under varied conditions. For example, the reacting step optionally includes one or more of, e.g., irradiating a composition comprising the monomers, heating a composition comprising the monomers, adding at least one catalyst to a composition comprising the monomers, and/or the like. The radiation utilized may be, for example, electromagnetic radiation, electron bombardment, or nuclear radiation. In certain embodiments, for example, an article or other substrate coated with a polymerizable composition described herein is exposed to the radiation source (e.g., a UV or electron beam radiation source), for a selected period of time. To further illustrate, one photon and/or two photon polymerizations are optionally utilized. Additional details relating to single and multiple photon polymerizations are provided in, e.g., Macak et al. (2000) “Electronic and vibronic contributions to two-photon absorption of molecules with multi-branched structures,” J. Chem. Phys. 113(17):7062, Luo et al. (2000) “Solvent induced two-photon absorption of push-pull molecules,” J. Phys. Chem. 104:4718, and Luo et al. (1994) “One- and two-photon absorption spectra of short conjugated polyenes,” J. Phys. Chem. 98:7782, which are each incorporated by reference. The intensity of light utilized to polymerize the monomers of the invention is typically between about 1 and about 1000 mW/cm², more typically between about 20 and about 800 mW/cm², and still more typically between about 50 and about 500 mW/cm², e.g., at wavelengths between about 315 and 365 nm. In addition, radiation exposure times are also varied, e.g., according to the particular monomer(s) used, the extent of double bond conversion desired, etc. To illustrate, the polymerizable compositions described herein are typically exposed to the particular radiation source from a few milliseconds to several minutes or more. In some embodiments, the monomers of the present invention achieve substantially complete or quantitative double bond conversion in less than 60 seconds (e.g., about 20 seconds or less) at 5 mW/cm, i.e., substantially quantitative double bond conversion is achieved at a dose typically less than 0.1 J/cm². Furthermore, polymerization temperatures are typically between 0° C. and 100° C. In preferred embodiments, polymerizations are performed at or near room temperature (e.g., 20-25° C.).

Following the polymerization reaction, the resultant polymeric material is typically pyrolyzed to form the ceramic material. For example, depending on the conditions employed for the thermal treatment, amorphous or crystalline structures can be obtained. Amorphous structures are generally obtained particularly when the pyrolysis is carried out in a temperature range from about 700 to 1200° C., preferably from 900 to 1200° C. When the thermal treatment is carried out at higher temperatures, for instance from 1200 to 2000° C., preferably from 1500 to 2000° C., at least partially crystalline structures are typically obtained. Pyrolysis is typically carried out under a protective gas cover or a reaction gas cover (e.g., helium, argon, nitrogen, ammonia, etc.) or in a vacuum. Further, pyrolysis is typically performed for about 0.5 to 2 hours to convert the polymeric material to a ceramic material. Optionally, a ceramic material is subjected to additional processing following pyrolysis. For example, a stable body is typically obtained after a sintering procedure at temperatures of up to 2000° C., preferably 1600-2000° C. for 0.5 to 2 hours.

The polymeric and/or ceramic materials of the invention can be included in essentially any article of manufacture, e.g., whether the polymeric and/or ceramic material forms the structure of the article, a component part of the structure, a coating (e.g., a primary coating, a secondary coating, etc.) of an article or substrate, or the like. Accordingly, no attempt is made herein to describe all of the possible applications of the polymeric and ceramic material of the present invention. However, certain exemplary embodiments are provided to further illustrate the present invention, but not to limit the invention. Additional applications of the polymeric and/or ceramic materials of the invention will be readily apparent to persons of skill in the art.

The polymeric and/or ceramic materials described herein are optionally included in articles, such as, dental restorative and other biomedical materials, fiber optic materials, lithographic materials (e.g., resists, for applications such as semiconductors, microfluidic devices, microelectronics, MEMS/NEMS, and nanolithography, etc.), membranes, adhesives, printing plates, inks, holographic materials, biomaterials, brake linings, electrical insulators (e.g., for spark plugs, etc.), valves and seals (e.g., for wear and corrosion resistance), high temperature windows, laboratory ware, high dielectrics, magnetics, liquid metal filters, fuel cells, radomes, medical prosthetics, oxygen sensors, electrodes, resistant heating, cutting tools, nozzles, bearing, and the like. The polymers of the invention are also optionally utilized as coatings, e.g., for optical fibers, optical disks, graphic arts, paper, wood finishes, ceramics, glass, and the like. Additional aspects of the present invention are provided in, e.g., the examples below, which illustrate certain monomer synthesis and purification protocols, and provide comparisons that illustrate some of the superior properties of the monomers described herein, including high reactivities and extents of monomer conversion to polymer.

In one aspect, the methods, compositions, and polymeric and/or ceramic materials of the invention are used in solid imaging and/or rapid prototyping, such as the fabrication of a three dimensional object. In certain embodiments, solid imaging and/or rapid prototyping includes the build up of successive solid laminae of sintered and/or polymeric material or imagable photopolymer through the use of actinic radiation directed at sinterable polymeric materials or imagable photomonomers. Optionally, the polymeric materials are liquids, pastes, gels, or the like. In addition, solid imaging and/or rapid prototyping are optionally performed, e.g., by three dimensional ink jet processes, or by image projection processes via masks or mirrors. These fabrication processes are typically used to create models to demonstrate form, fit and function or rapid tooling and parts manufacture on demand. For example, the fabrication of three-dimensional representations of an object, component or structure from digital data according to the present invention may be via stereolithography, selective laser sintering, laminated object manufacturing, fused deposition modeling, and/or 3D-plotting with ink jet printers.

For use in stereolithography, a composition is typically photosensitized such that the absorbance of light at a laser wavelength creates a Dp (i.e., a penetration depth at which the beam intensity is reduced to 1/e of its surface value) of between 20-250 μm. It is generally preferred that the Dp be approximately the same as the layer thickness for the greatest exposure efficiency. The Dp is measured by scanning, for example, 1 cm squares on the surface of the liquid. Several squares are formed and given different exposures by changing the laser power and/or the exposure time (usually faster or slower scanning speed). When scanning the squares on the surface, it is often preferable that the 1/e² diameter of the focused beam be taken into account. In order to provide a uniform exposure, lines are drawn side-by-side in parallel fashion with the distance between the lines 40% of the 1/e² beam diameter or less. If the laser is a pulsed laser, in order to achieve a uniform exposure, the spacing of the beam pulses along the line should be such that each pulse is 40% of the 1/e² beam diameter or less. It is possible to provide exposures with greater than the 40% overlap but the exposure becomes less and less uniform in the exposure region. It is generally preferred that the range of exposure, provided to the various squares, be on average the typical exposure needed to expose a layer. Typically, for stereolithography compositions, such exposures are in the range of 5-800 mW/cm² and most typically in the range of 20-150 mW/cm². But this will vary depending on the number of cross-link species or the amount of non-actinic absorption from the composition.

Once the squares have been formed, they are removed from the surface of the composition and the thickness is measured using calipers. If the thickness of the various layers is plotted (Y-axis) against the natural log of the sum of exposure (summing, for example, Gaussian exposures over an area using calculation methods well known in the art) along the X-axis and a least squares line fit is applied to the data, the slope of the line is the Dp. The Dp is typically modified to be on the order of the layer thickness by changing the concentration of absorbing sensitizing or initiating species or changing the type of sensitizing or initiating species. For example, for a composition that is essentially non-absorbing at a laser wavelength of 354.7 nm used in a process where layers are coated in 150 um thicknesses, approximately 3.2% of Irgacure 651 (Ciba) would produce a composition Dp of 150 μm. Alternatively, for example, only 0.21% of Irgacure 369 (Ciba) would be required to produce a Dp of 150 μm. Higher concentrations would lower the Dp and lower concentrations would increase the Dp. The concentrations may vary slightly from composition to composition depending on absorption shift effects.

Once a composition is prepared having the desired Dp for the stereolithography process, it is poured into a vat. Within the vat is positioned a platform with a surface substantially parallel with the surface of the composition in the vat. A layer of composition is applied to the platform surface and optionally smoothed using a doctor blade. The layer has a thickness. Exposure is provided by scanning the laser beam imagewise across the layer surface. The amount of exposure provided is the amount necessary to create a polymerized layer at least as thick as the layer thickness. Next, another layer is coated above the platform and on the previously exposed layer region. This is then scanned imagewise providing an exposure that polymerizes the layer of composition at least as thick as the coating thickness above the previous hardened layer region. It is often preferable to provide extra exposure to ensure that the hardened layer adheres to the platform or to at least a portion of the previous layer. This assures that the layers adhere to each other forming contiguous layers. The process is continued, coating a layer and providing imagewise exposure to the layer until all layers have be coated and hardened. Then the hardened contiguous object is removed from the surrounding composition, cleaned of unpolymerized composition with a mild solvent, and allowed to dry. The object is optionally then placed in a post-curing apparatus, which provides a UV exposure to the object. This UV post-exposure further hardens the surface of the object and provides, to some depth, increased exposure and therefore increased polymerization and object strength. Additional details relating to stereolithography are provided in, e.g., U.S. Pat. No. 5,167,882, entitled “STEREOLITHOGRAPHY METHOD,” issued Dec. 1, 1992 to Jacobine et al., which is incorporated by reference.

It is understood that the examples and embodiments described herein are for illustrative purposes and that various modifications or changes in light thereof will be suggested by the teachings herein to persons skilled in the art and are to be included within the spirit and purview of this application and scope of the claims.

### EXAMPLES

### Example I

Experimental

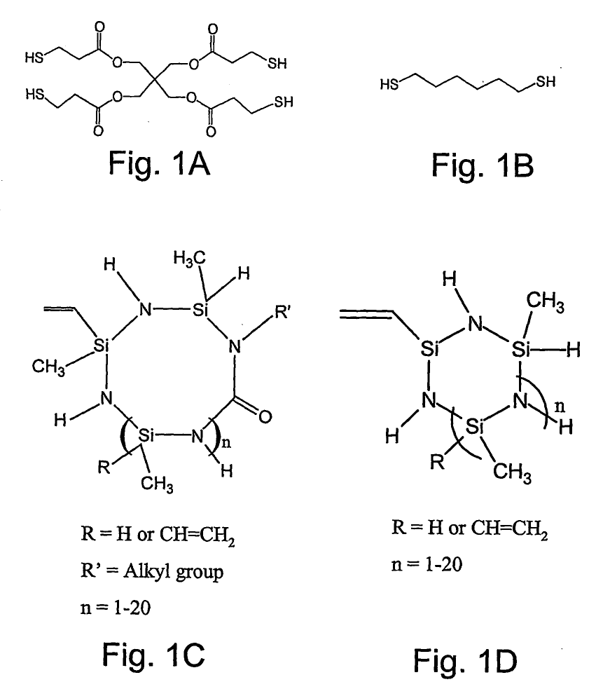

The monomers utilized in this example were pentaerythiritol tetra(3-mercaptopropionate) (tetrathiol) (donated), 1,6-hexanedithiol (dithiol) (Aldrich, Milwaukee, Wis.), and vinyl containing ceramic precursor monomers, VL20 and CERASET (Kion Corporation, New York, N.Y.). The photoinitiator utilized was 2,2-dimethoxy-2-phenyl acetophenone (DMPA) (Ciba-Geigy, Hawthorne, N.Y.). All monomers and the photoinitiator were used as received, and the structures of the monomers used are shown in FIGS. 1A-D.

FTIR studies were conducted using a Nicolet 750 Magna FTIR spectrometer with a KBr beamsplitter and an MCT/A detector. Series scans were recorded, taking spectra at the rate of approximately 5 scans per second while the FTIR sample chamber was continuously purged with dry air. Samples were irradiated until the reaction was complete, as indicated by the double bond and thiol peak absorptions remaining constant. Thiol functional group conversion was monitored using the S—H absorption peak at 2570 cm⁻¹, while vinyl conversions were monitored using the carbon-carbon double bond absorption peak at 1593 cm⁻¹. Conversions were calculated using the ratio of peak areas to the peak area prior to polymerization. Analyses and apparatus for FTIR experiments are described further in, e.g., Lovell et al. (2001) Polym. Advan. Technol. 12:335 and Berchtold et al. (2001) Macromolecules 34:5103.

For kinetic studies, monomer samples were placed between NaCl crystals in a horizontal transmission apparatus (Lovell et al. (2001), supra). Photopolymerizations were initiated via an EXFO ACTICURE® light source (EXFO, Mississauga, Ontario) with a 320-500 nm filter. Note that the EXFO ACTICURE® light source used a medium pressure mercury bulb that had a principle output in the range of 365 nm. Irradiation intensities were measured with an International Light, Inc. Model IL1400A radiometer (Newburyport, Mass.). All reactions were performed under ambient conditions.

Contact lithography was employed in the fabrication of the photopatterned polymer structures. Contact printing, where the solution is exposed to UV through a mask placed directly on the photopolymerizable monomers, limits diffraction effects from the UV light exiting the mask. Thus, the resolution of contact printing is higher than many other optical lithography processes (Madou, Fundamentals of Microfabrication, CRC Press, LLC, Boca Raton, Fla. (1997)). This processing route for SiCN is well-suited for low cost, mass-scale fabrication of MEMS. Photomasks for lithography were designed using DW-2000™ layout editor software. The designs were then printed on transparencies using a high resolution printer. A thin layer of TEFLON® was coated on the photomask to facilitate easy removal of patterened structures from the mask after the exposure (Cross et al. Technical Digest of the Fifteenth IEEE International Conference on MICRO ELECTRO MECHANICAL SYSTEMS; MEMS—2002:20-24 January 2002, Las Vegas, Nev., USA).

The polymer structures were pyrolyzed in a nitrogen atmosphere to convert the polymer into the ceramic, a silicon carbon nitride (SiCN) material. The pyrolysis procedure consisted of heating the polymer sample at a rate of 10° C./min to 400° C., holding at 400° C. for one hour, further heating at a rate of 1° C./min to 700° C. and holding at 700° C. for four hours and, finally, heating at a rate of 1° C./min to 1000° C. and holding at 1000° C. for four hours. The sample was then cooled at a rate of 1° C./minute to ambient temperature.

Results

Table I shows the final double bond conversion, thiol conversion, and initial polymerization rate in four mixtures having varying weight ratios of VL20:Tetrathiol. Polymerization kinetics of these mixtures were studied under identical conditions: 0.02 wt % of photoinitiator (DMPA) and irradiation at 2 mW/cm². Under these curing conditions, no double bond conversion was observed in pure VL20 system even after exposure for 1 hour.

TABLE I

| | Molar Ratio | | | |
|---|---|---|---|---|
| Weight Ratio | of Ene:Thiol | Final Double | | Initial |
| of VL20: | Functional | Bond | Final Thiol | Polymerization |
| Tetrathiol | Groups | Conversion | Conversion | Rate (1/s) |
| 8:1 | 2.96:1 | 34% | 100% | 0.014 |
| 5:1 | 1.85:1 | 55% | 100% | 0.035 |
| 2.7:1 | 1:1 | 100% | 100% | 0.041 |
| 1:0 | — | 0% | — | 0.00 |

Table II shows the average mass loss and linear shrinkage measurements (relative to the sizes and masses of the structures immediately after photopolymerization) for VL20 and tetrathiol-VL20 systems, during pyrolysis. The tetra thiol-VL20 system was cured with 0.02 wt % DMPA, while the VL20 system was cured with 6 wt % DMPA. Values are an average for measurements on six test samples.

TABLE II

| | Tetrathiol - VL20 | VL20 |
|---|---|---|
| Mass Loss | 39.1% ± 1.0% | 34.2% ± 1.8% |
| Linear Shrinkage | 32.6% ± 1.6% | 34.9% ± 2.2% |

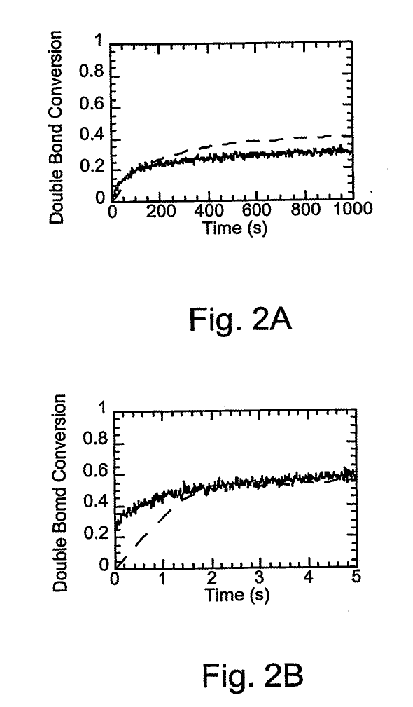

Both dithiol and tetrathiol monomers were polymerized with the vinyl containing preceramic monomers VL20 and CERASET. Photopolymerization of these preceramic monomers via a thiol-ene mechanism drastically improves the polymerization kinetics without any apparent degradation of the final ceramic properties. The observed polymerization kinetics are presented in FIG. 2. It was found that the addition of thiol monomers to VL20 and CERASET increases the polymerization rate by several orders of magnitude. Without the thiol, the bulk VL20 monomer with 6 wt % added photoinitiator reached 35% conversion in approximately 400 seconds, with the final conversion being 40% after 1200 seconds of exposure. However, with the addition of only 16 wt % tetrathiol monomer to the bulk VL20 system and in the presence of only 0.02 wt % DMPA, 55% double bond conversion was attained in approximately 2 seconds. This mixture represented a ratio of 1.85:1 of vinyl to thiol functional groups. The initial polymerization rate, final conversion of thiol and ene functionalties achieved in these thiol-VL20 systems for varying ratios of thiol:VL20 are presented in Table I. In contrast, CERASET with 1.3 wt % added photoinitiator and without thiol requires nearly 300 seconds to achieve 25% conversion, with the final conversion being 34% after 1200 seconds. With the addition of 50 wt % tetrathiol monomer to the system, 50% conversion is attained in approximately 2 seconds utilizing only 0.7 wt % DMPA.

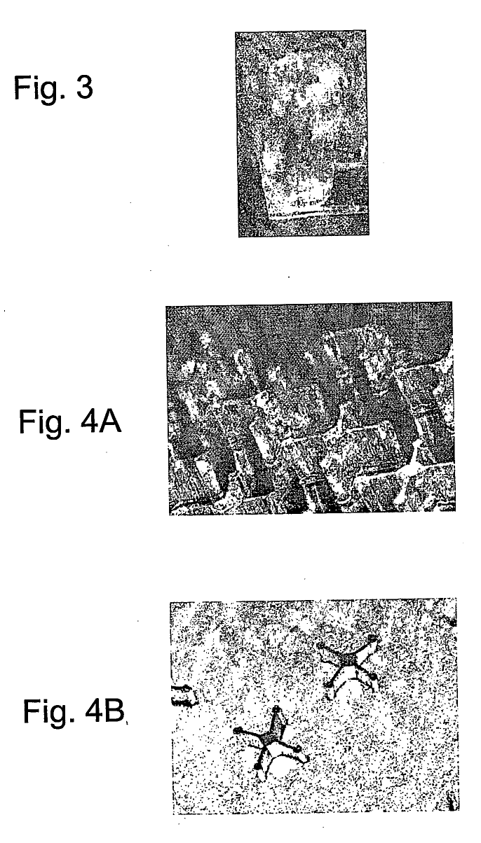

In photopolymerizations, the absorption of irradiating light is primarily due to the photoinitiator molecule and thus the photoinitiator concentration is the primary factor influencing achievable curing depths. Very low photoinitiator concentrations in thiol-ene systems still result in very high cure rates. Thus, these systems have a very high optical transparency, which facilitates the formation of thick structures. For example, a masked and photocured tetrathiol-VL20 system with 0.02 wt % DMPA was successfully performed, maintaining the masked pattern in a sample with a thickness of 6 mm as shown in FIG. 3.

The high cure depths in thiol-ene systems also facilitate achievement of higher aspect ratios. The largest cure depth obtained from the bulk CERASET and 5 wt % DMPA solution has been observed to be approximately 700 microns. In contrast, a cure depth of 1200 microns was achieved for a device of 80 microns in width from the dithiol-CERASET solution with 0.2 wt % DMPA, having an aspect ratio of 15:1, as shown in FIG. 4.

Polymer structures made from thiol-ene reactions exhibit similar shrinkage and mass loss during the pyrolysis step, relative to bulk VL20 or CERASET structures. Mass loss and volume shrinkage for the tetrathiol-VL20 and homopolymerized VL20 systems are indicated in Table II, above.

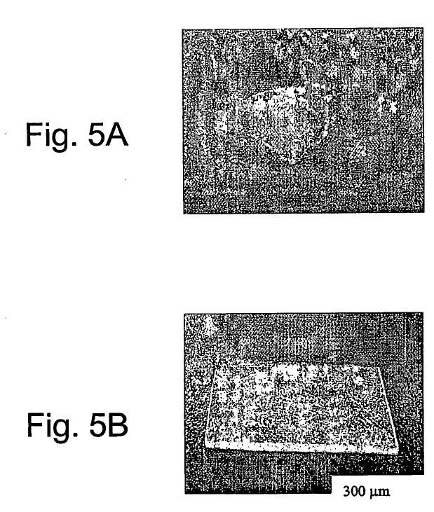

In addition to improved kinetics, utilizing a thiol-ene polymerization results in the ability to make structures that do not warp. Structures from photopolymerization of pure polysilazane monomers exhibit significant warping (Liew et al. (2001) Am. Ceram. Soc. Bull. 80:25). FIG. 5 compares the shape of similar films formed by homopolymerization of VL20 and by polymerization of VL20 with 16 wt % tetrathiol. The structure made from thiol-VL20 is flat relative to the bulk polymerized VL20 structures. Due to their step growth mechanism and the concomitant gel point delay, thiol-ene systems exhibit significantly less stress development as compared to traditional vinyl homopolymerization systems. The lowered stress in thiol-ene systems results in reduced warping in the polymer structures. Elimination of warping in these devices is highly desirable for integration of these structures into other microstructures or devices.

The polymerization rate of vinyl containing preceramic monomers VL20 and CERASET is increased by several orders of magnitude upon addition of thiol monomers to the system. The very low initiator concentrations required for polymerization of these systems facilitate the formation of thick structures with high aspect ratios. Warping, which has been observed in the structures formed through photopolymerization of pure ceramic precursors, is largely eliminated by copolymerization with thiol monomers. In the pyrolysis step, mass loss and linear shrinkage of the structures formed using these reaction schemes were similar to those observed in structures made from pure polysilazane systems.

### Example II

Pentaerythritol tetra(3-mercaptopropionate) and (a KiON™ VL20 polysilazane) were copolymerized, under identical conditions (other than having far less initiator) to those of a non-thiol containing system that comprised only the polysilazane. The results showing cure times and overall conversions for bulk polysilazane (VL20 polysilazane) and a thiol/polysilazane mixture (thiol/VL20 polysilazane) consisting of 1:5 weight fraction of thiol to polysilazane monomers are presented in Table III. The samples were irradiated at 57 mW/cm² using 6 wt % DMPA as the photoinitiator for VL20 bulk polymerization and 0.02 wt % for the thiol-VL20 polymerization. Note that the thiol-ene photopolymerization achieved the same conversion in 1-2 seconds as the traditional photopolymerization achieved in approximately 500 seconds despite the presence of 300 times more initiator in the traditional system.

TABLE III

| | Cure | Percent Double Bond |
|---|---|---|
| Polymerization | Time (seconds) | Conversion |
| Bulk KiON ™ VL20 | 600 | 40 |
| Polysilazane | | |
| Pentaerythritol tetra-(3- | 2 | 50 |
| mercaptopropionate)/ | | |
| KiON ™ VL2O | | |
| Polysilazane | | |

### Example III

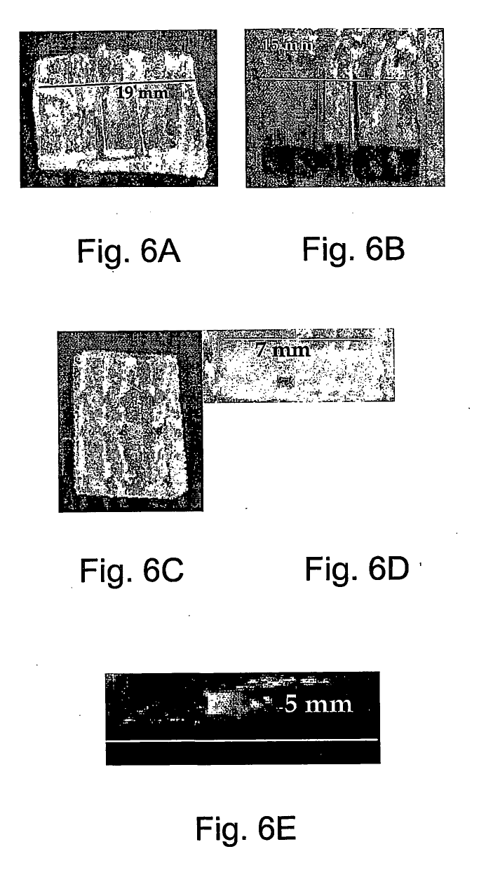

Thiol-ene photopolymerizations also lead to enhanced capabilities in photolithographic processes including low shrinkage and greater resolution. This is depicted in FIGS. 6A-E, which show images of a photolithographic mask, polymer, and pyrolized ceramic. More specifically, FIG. 6A shows a polymer 2-D channel of 800 μm made from 1:5 (wt ratio) of tetrathiol:VL20. FIG. 6B shows a pyrolyzed sample made from the pyrolysis of the device shown in FIG. 6A. FIGS. 6 C and D show a top view and a side view, respectively, of an 800 μm polymer 3-D channel filled with red dye. FIG. 6E shows the sample from FIGS. 6 C and D after pyrolysis with the 3-D channel. Decreased quantities of initiator molecules allow for formation and patterning of much thicker samples than can typically be achieved with traditional polymerization systems. Thiol-ene polymerizations can, in fact, be conducted without any added photoinitiator molecules (Cramer et al. (2002) Macromolecules 35:5361). Inherent in a step growth thiol-ene polymerization is that the polymer is more homogeneous in nature than a traditional free radical polymerization. This may also contribute to enhanced stability and properties of pyrolyzed structures. This is evidenced by the fact that under similar pyrolysis conditions, samples 2.5 mm thick made from photopolymerization of thiol-polysilazane remained intact to give good feature sizes while samples made from photopolymerization of pure polysilazane, in spite of being only 1.0 mm thick, crumbled upon similar pyrolysis conditions.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above may be used in various combinations. All publications, patents, patent applications, or other documents cited in this application are incorporated by reference in their entirety for all purposes to the same extent as if each individual publication, patent, patent application, or other document were individually indicated to be incorporated by reference for all purposes.

What is claimed is:

1. A composition, comprising:
(a) at least a first monomer comprising at least one ethylenically unsaturated group, and at least one Si—N linkage, at least one Si—O linkage, and/or at least one Si—C linkage; and,
(b) at least a second monomer comprising at least one thiol functional group.

2. The composition according to claim 1, wherein the first monomer comprises at least one vinyl functional group.

3. The composition according to claim 1 or 2, wherein the first monomer comprises at least three Si—N linkages, at least three Si—O linkages, and/or at least one Si—C linkages.

4. The composition according to anyone of claims 1-3, wherein the second monomer comprises two or more thiol functional groups.

5. The composition according to anyone of claims 1-4, wherein the first monomer is represented by formula (I): 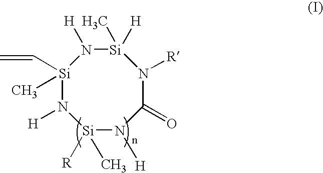
wherein n is an integer from 1-20, R is H or CH═CH₂, and R′ is an organic group comprising from 1-20 carbon atoms.

6. The composition according to anyone of claims 1-5, wherein the first monomer is optionally represented by formula (II): 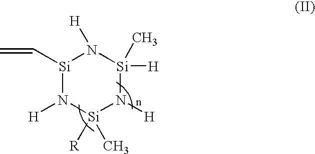
where R is H or CH═CH₂, and n is an integer from 1-20.

7. The composition according to anyone of claims 1-6, wherein the second monomer is represented by formula (III):

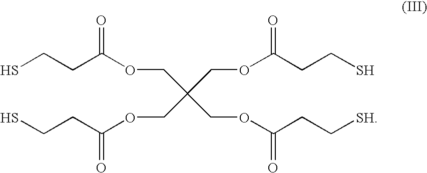

8. The composition according to anyone of claims 1-7, wherein the composition comprises a photoinitiator.

9. A method of forming a ceramic material, the method comprising:
(a) reacting at least a first monomer comprising at least one ethylenically unsaturated group with at least a second monomer comprising at least one thiol functional group to form a polymeric material; and,
(b) heating the polymeric material to form the ceramic material.

10. The method according to claim 9, wherein the first monomer comprises at least one vinyl functional group.

11. The method according to claims 9 or 10, wherein the first monomer comprises at least one Si—N linkage, at least one Si—O linkage, and/or at least one Si—C linkage.

12. The method according to anyone of claims 9-11, wherein the second monomer comprises two or more thiol groups.

13. The method according to anyone of claims 9-12, wherein the first monomer is represented by formula (I): 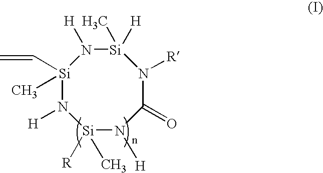
wherein n is an integer from 1-20, R is H or CH═CH₂, and R′ is an organic group comprising from 1-20 carbon atoms.

14. The method according to anyone of claims 9-13, wherein the first monomer is optionally represented by formula (II): 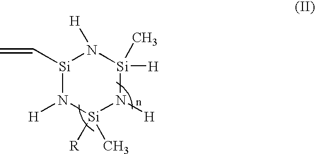
where R is H or CH═CH₂, and n is an integer from 1-20.

15. The method according to anyone of claims 9-14, wherein the second monomer is represented by formula (III):

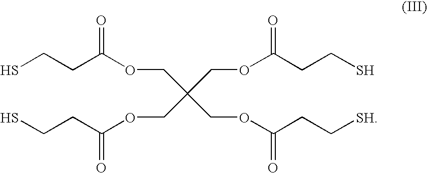

16. The method according to anyone of claims 9-15, wherein the molar ratio of the first monomer to the second monomer is at least 1:1 in step (a).

17. The method according to anyone of claims 9-15, wherein the molar ratio of the second monomer to the first monomer is more than 1:1 in step (a).

18. The method according to anyone of claims 9-17, wherein step (b) comprises pyrolyzing the polymeric material to form the ceramic material.

19. The method according to anyone of claims 9-18, wherein step (b) is performed at a temperature of at least 700° C.

20. A method of forming a three-dimensional ceramic material comprising:
(1) coating a layer of a composition onto a surface, wherein the composition is used as defined in anyone of claims 1-8;
(2) exposing the layer imagewise to actinic radiation to form an imaged cross-section, wherein the radiation is of sufficient intensity to cause substantial curing of the layer in the exposed areas;
(3) coating a layer of the composition onto the previously exposed imaged cross-section;
(4) exposing the layer from step (3) imagewise to actinic radiation to form an additional imaged cross-section, wherein the radiation is of sufficient intensity to cause substantial curing of the layer in the exposed areas and to cause adhesion to the previously exposed imaged cross-section;
(5) repeating steps (3) and (4) a sufficient number of times in order to build up a three-dimensional article; and,
(6) pyrolyzing the three dimensional article to form the three dimensional ceramic material.

21. The method according to claim 20, further comprising separating exposed regions of the layer of the composition from unexposed regions of the layer of the composition.

22. The method according to anyone of claims 9-21, further comprising:
(c) sintering the ceramic material.

23. The ceramic material made by the method of anyone of claims 9-22.

24. An article comprising the ceramic material of claim 23.
